(19) United States
(12) Patent Application Publication
(10) Pub. No.: US 2011/0139601 A1
(43) Pub. Date: Jun. 16, 2011

(54) SOLAR STILLS

(75) Inventor: Peter Johnstone, Victoria (AU)

(73) Assignee: FIRST GREEN PARK PTY LTD, Victoria (AU)

(21) Appl. No.: 12/989,354

(22) PCT Filed: Apr. 22, 2009
(86) PCT No.: PCT/AU09/00503

§ 371 Date: Jan. 18, 2011

(30) Foreign Application Priority Data
Apr. 24, 2008 (AU) 2008902054
May 16, 2008 (AU) 2008902433
Sep. 19, 2008 (AU) 2008904898

(51) Int. Cl. B01D 3/02

(52) U.S. Cl. 202/180

(57) ABSTRACT

A solar still module for use in a solar still arrangement for producing a desired condensate from a feed treatment liquid. The solar still module includes a treatment chamber including a treatment member positioned below an upper solar energy transmission wall to receive, in use, solar energy therethrough. The solar still module includes a treatment liquid supply supplying treatment liquid to an upper end of a first region of the treatment member to flow in a liquid film flow gravitationally downwardly thereover while a component of the treatment liquid is at least partially evaporated and condensed to form a condensate on an inner surface of the upper solar energy transmission wall. The condensate flows gravitationally downwardly on the inner surface of the upper solar energy transmission wall and is collected at a lower location by condensate collection and discharge means. The upper solar energy transmission wall is formed by a clear or highly translucent polymer material with the inner surface being hydrophilic relative to the condensate. The treatment member is formed by a thin metal material as a tray having a tray base forming the first region. A perimeter wall extends upwardly from the tray base along at least side edges and lower edges of the tray base. An outwardly extending flange extends from an upper region of the perimeter wall. The flange is supported on a support frame.

### PRIORITY CLAIM

The present application is a National Phase entry of PCT Application No. PCT/AU2009/000503, filed Apr. 22, 2009, which claims priority from Australian Patent Application No. 2008902054, filed Apr. 24, 2008, Australian Patent Application No. 2008902433, filed May 16, 2008, and Australian Patent Application No. 2008904898, filed Sep. 19, 2008, the disclosures of which are hereby incorporated by reference herein in their entirety.

### TECHNICAL FIELD

The present invention relates to improvements in solar stills for producing a desired condensate from a liquid supply stream by the application of solar energy. Typically, but not exclusively, the desired condensate might be clean or fresh water produced from a saline, brackish or otherwise contaminate laden supply stream. The condensate may also be an alcohol such as ethanol evaporated from a supply stream containing same which is condensed and separately removed from the solar still.

In hybrid arrangements, stills according to embodiments of the present invention can be operated utilizing heated water supplies, for example from industrial or geothermal applications, where the still can be operated with minimal or no solar energy application.

### BACKGROUND ART

The specification will describe embodiments of the invention primarily in relation to the context of producing a clean or fresh water supply as the generated condensate but it should be appreciated that other applications are possible. The capability of providing enough clean or fresh water for a variety of purposes including providing drinking water, and for irrigating crops without the salt build up in land structures commonly associated with use of artesian water, is becoming an increasing problem for the planet. This is particularly the case for relatively dry and arid areas such as Australia, but is also a problem for many other areas of the world. Solar stills are known where otherwise unusable water such as artesian water, sea water, or polluted water sources such as water from mines or industry can be heated by exposure to the sun, condensed as clean fresh water and collected for subsequent use. There have been many proposals for solar stills, however, they generally are all characterized by being expensive to produce and use relative to the quantity of fresh clean water produced. Solar stills that are currently in use are used for particular applications where the cost of clean fresh water production is not a major issue, such as for example, survival applications.

One known solar still module available under the trade name SUNSURE comprises a substantially air tight panel construction adapted to be supported in an inclined manner to receive solar energy applied against an upper glass wall. A plastic tray member is positioned beneath the glass wall and defines an array of small ponds or reservoirs whereby saline water or similar to be treated can be positioned therein to be subjected to solar energy transmitted through the upper wall. Generated water vapour condenses on the underside of the glass wall and is collected to be discharged from the module.

Some examples of other proposals for solar still configurations can be seen in U.S. Pat. No. 7,008,515, US Publication No. 2003/0033805, WO 91/14487, UK 2345002, DE 19704046, DE 10044344 and WO 2008/043141. This acknowledgement of these prior art patent disclosures should not be taken as a recognition that the disclosures are common general knowledge in the solar still industry. For reasonably larger scale production of clean fresh water, solar stills despite using a relatively free source of energy, have generally remained a quite expensive option.

### SUMMARY OF THE INVENTION

Embodiments of the present invention is to provide an improved solar still module that is a simpler construction and is also efficient in producing clean condensate from a liquid feed stream, particularly but not exclusively for producing clean water from a contaminated, brackish or saline water supply. The simple construction aims at achieving a lower capital cost of installations including one or more such solar still modules.

Accordingly, embodiments of the present invention may provide a solar still module having a treatment chamber treatment chamber including a treatment member positioned below an upper extremity of the treatment chamber, a treatment liquid supply supplying treatment liquid to an upper end of a first region of the treatment member, the first region having, in use, at least one inclined upwardly facing surface to promote the treatment liquid flow gravitationally downwardly on the first region of said treatment member in one or more flows, the upwardly facing surface or surfaces of the first region being hydrophilic relative to the treatment liquid whereby the treatment liquid spreads into a thin film on the upwardly facing surface or surfaces of the first region, the first region further including at least one porous material layer at least partially covering the or each of the upwardly facing surface or surfaces, the treatment chamber having an upper solar energy transmission wall positioned above the first region of the treatment member enabling solar energy to be applied at least to the first region of the treatment member to at least partially evaporate a component of the treatment liquid on the first region, the evaporated component being at least partially condensed on an inner surface of the upper solar energy transmission wall to form a condensate, the condensate being collected therefrom at a lower location or locations by condensate collection and discharge means leading from said the treatment chamber.

According to one embodiment of the present invention, the upwardly facing surface or surfaces of the first region is heat conductive and/or capable of reflecting solar energy. The upwardly facing surface or surfaces of the first region are heat conductive. In an embodiment, the treatment panel member is a preformed sheet metal member having a first inclined wall forming said first region. The preformed sheet metal member has a thin wall structure. In an embodiment, the sheet metal member is aluminium or aluminium alloy or is copper or a copper alloy. In another embodiment, the sheet metal member may be a stainless steel material. In an embodiment, the preformed sheet metal member is pressed from a thin walled metal foil material. In an embodiment, the sheet metal member is a tray member having at least upstanding side walls and a lower upstanding wall connecting lower ends of the side walls. In another embodiment, a layer may be bonded to the upwardly facing surface or surfaces of the first region, the layer having an upwardly facing hydrophilic surface formed thereon.

In an embodiment of the present invention, the tray member forming the treatment panel member may be supported on a rectangular perimeter frame having two opposed side arms and two opposed end arms. The tray member may have dimensions of about three meters in length and about one to two meters in width. In use the tray member may be supported having the longer side edges inclined at an angle of between 10° and 55°, preferably about 30°.

In an embodiment of the present invention, the porous material layer is a treatment liquid absorbent or hydrophilic in nature material that may be woven or non-woven. When clean water is to be produced from the still module, the porous material layer has a weight/area of no more than 200 gm/square meter, preferably between 10 and 80 gm/square meter. Suitable materials will include but not be limited to natural fiber materials such as wool, propylene, polyester and polyester blended materials including a blend of polyester and rayon. It is desirable that the material is hydrophilic in nature, ie will absorb the treatment liquid. The fabric material, where possible, should also be UV stabilized to provide more effective use periods. If it is desired that the porous material catch and retain materials that might settle out of the treatment liquid, then the porous material layer may be heavier or thicker than the above weights/area. Felt materials such as an acrylic felt material might be used in such applications.

In an embodiment, the upper solar energy transmission wall may include an inner facing clear or highly translucent hydrophilic surface relative to the condensate formed therein. This enables the condensate to form into a film and readily flow downwardly under gravitational loading on the surface to be collected at a lower collection location or locations. The film of condensate on the inner surface has been found to clarify the surface and improve the passage of solar energy therethrough to be applied to the treatment liquid on the treatment member without adversely affecting the downward flow of condensate on the inner surface. The hydrophilic surface is formed either by mechanical means such as acid etching the inner surface of the polymer material forming the flexible sheet or by applying a coating or layer to the inner surface such as an oxide layer, silicon oxide, titanium oxide or aluminium oxide. In another embodiment, the polymer sheet material or its inner surface may be hydrophobic in nature. This allows the condensate to bead on the inner surface and to flow downwardly thereon, however, the performance achieved is significantly less than that achieved by having a hydrophilic inner surface. If a hydrophobic surface is used, then a fluorinated polymer material coating or layer might be employed such as polytetrafluoroethylene (PTFE). In an embodiment, the upper solar energy transmission wall may be formed by a first sheet of a preformed flexible polymer material. The polymer material is a material capable of being formed by application of heat. The polymer material may be polycarbonate, polyester, PET, polypropylene, polyethylene, acrylic or acetyl. In an embodiment, the polymer material includes UV stabilizing materials to minimize any deterioration by solar exposure. Such polymer material can be constructed into a thin walled flexible sheet material that is sufficiently robust in use to withstand normal wear and tear that the solar still module may endure. Glass sheets might also be possible but could be a more expensive option. It is desirable that the solar energy transmission wall has a thin wall structure that may be flexible but not substantially resilient or elastic. The polymer material forming the upper solar energy transmission wall is either clear or highly translucent to allow solar energy to pass therethrough.

The solar still module may further include at least one spacer element enabling, where used, the flexible preformed thin walled polymer material sheet member to be positioned spaced above the first region of the treatment member. Such spacing ensures a practical separation between the treatment liquid on the treatment member and the condensate formed on the thin walled polymer sheet material. The spacing also enables convection air/vapor flow upwardly above the treatment member and downwardly along the rear surface of the treatment member. The spacer element or elements may be integrally formed with the treatment panel member or may be separately formed and positioned thereover. The treatment chamber may include a lower wall spaced from a lower extremity of the liquid treatment member, the lower wall being formed by a second sheet of a preformed thin walled flexible polymer material. The lower wall may be made from a similar material as the upper solar energy transmission wall although the lower wall does not of course need to be clear or highly translucent. The upper and the lower walls forming the treatment chamber may be secured together along peripheral edges to surround the treatment member. The upper and lower walls are arranged close to but spaced from the treatment member. Spacer elements may also be provided at or adjacent to upper or lower edges of the treatment member to ensure separation between the upper and lower walls forming the outer envelope of the solar still module. Such additional spacer elements may engage with the upper and lower ends of the treatment member so as to maintain separation of the forward condensate and treatment liquid and to enable convection air/vapor flow about the treatment member during operation of the solar still module. The spacing is within the range of 10 to 40 mm.

In accordance with a second aspect, embodiments of the present invention provide a solar still module having a treatment chamber including an upper solar energy transmission wall formed by a preformed polymer sheet material positioned at or above an upper extremity of the treatment chamber, the solar energy transmission wall being clear or highly translucent at least in a first region intended to transmit solar energy into the treatment chamber having a preformed laterally extending formation along at least one edge region, the solar energy transmission wall providing an inner hydrophilic surface on which an evaporated component condenses to form a condensate. The treatment chamber further has a second lower wall formed by a second sheet of a preformed polymer material having a preformed laterally extending formation along at least one edge region, the preformed laterally extending formations on the first upper and the second lower walls being connectable to form the treatment chamber. The inner surface of the first region may be formed by mechanical means including acid etching of an inner surface of the polymer sheet material. In another embodiment, the inner surface of the first region may be formed by a hydrophilic material coating or layer such as an oxide including silicon oxide, titanium oxide, or aluminium oxide. The material should however be clear or highly translucent in use with a condensate liquid film thereon.

According to yet another aspect, embodiments of the present invention provides a solar still module having a treatment chamber including a treatment member positioned below an upper extremity of the treatment chamber, a treatment liquid supply means supplying treatment liquid to at least an upper end of a first region of the treatment member, the first region of the treatment member being formed from a thin metal sheet material whereby the treatment liquid delivered by the treatment liquid supply means is disposed in a thin treatment liquid film flow or flows over the first region to flow gravitationally downwardly thereon, the treatment chamber having an upper solar energy transmission wall positioned above the first region of the treatment member enabling solar energy to be applied at least to the first region to evaporate at least a portion of a component of the treatment liquid, the evaporated component being at least partially condensed on an inner surface of the upper solar energy transmission wall to form a condensate thereon, the upper solar energy transmission wall of the treatment chamber being formed by a first sheet of a preformed polymer material having a preformed laterally extending formation along at least one edge region, the upper solar energy transmission wall, in use, being clear or highly translucent with a hydrophilic inner surface relative to the condensate whereby the condensate formed thereon spreads into a film to flow downwardly thereon to the lower location or locations for collection, the treatment chamber further having a lower wall formed by a second sheet of a preformed polymer material having a preformed laterally extending formation along at least one edge region.

In accordance with a still further aspect, embodiments of the present invention provide a solar still module having a treatment chamber including a treatment member positioned below an upper extremity of the treatment chamber, a treatment liquid supply means supplying treatment liquid to an upper end of a first region of the treatment member formed from a thin metal sheet material whereby the treatment liquid delivered by the treatment liquid supply means is disposed in a thin treatment liquid film flow or flows over the first region, the treatment chamber having an upper solar energy transmission wall positioned above the first region of the treatment member enabling solar energy to be applied at least to the first region of the treatment member to evaporate at least a portion of a component of the treatment liquid, the evaporated component being at least partially condensed on an inner surface of the upper solar energy transmission wall to form a condensate that is collected therefrom at a lower location or locations by condensate collection and discharge means leading from the treatment chamber, the treatment chamber being formed by a first upper member of a polymer sheet material and by a second lower member of a polymer sheet material, at least some edge regions of the first upper member and the second lower member having formations formed along the edge regions extending laterally therefrom, the solar still module further including at least one tubular member engaging an edge region of the first upper member and the second lower member whereby the formations formed along the edge region are retained by the tubular retainer member. The first member is integrally joined to the second lower member along one the edge region. In an embodiment, the tubular retainer member is located along a lower edge region of the first upper member and the second lower member, the retainer member providing a substantially enclosed inner zone to collect the condensate from at least the inner surface of the upper first upper member forming the solar energy transmission wall. In an embodiment, the tubular retainer member positioned along the lower edge region is inclined downwardly towards one side of the solar still module. This allows condensate collected within the retainer member to flow towards said one side for discharge from the solar still module. In an embodiment, the preformed formations extend laterally and form a ridge along the edge region which may be generally semi-circular when viewed in cross-section.

According to a further aspect of embodiments of the invention, a solar still module may be provided having a treatment chamber including a treatment member positioned below an upper extremity of said treatment chamber, a treatment liquid supply means supplying treatment liquid to an upper end of a first region of the treatment member whereby the treatment liquid delivered by the treatment liquid supply means is disposed in thin treatment liquid film flow or flows over the first region to flow gravitationally downwardly thereon, the treatment chamber having an upper solar energy transmission wall positioned above the first region of the treatment member enabling solar energy to be applied at least to the first region of the treatment member to evaporate at least a portion of a component of the treatment liquid, the evaporated component being at least partially condensed on an inner surface of the upper solar energy transmission wall to form a condensate that is collected therefrom at a lower location or locations by condensate collection and discharge means leading from the treatment chamber, the upper solar energy transmission wall of the treatment chamber being formed by a clear or highly translucent polymer material layer with a hydrophilic inner surface relative to the condensate, the water treatment member being formed from a thin metal material as a tray having a tray base forming the first region, a perimeter wall extending upwardly from the tray base along at least side and lower edges of the tray base, and an outwardly extending flange extending from an upper region of the perimeter wall, the flange being supported on a support frame. The first region of the treatment member has at least one upwardly facing hydrophilic surface. In an embodiment of the present invention, the hydrophilic surface is formed by an oxide layer on the first region. In an embodiment of the present invention, the treatment member includes a preformed aluminium or aluminium alloy metal foil tray member and the oxide layer is an aluminium oxide layer. In another embodiment, the treatment member may be made from stainless steel.

According to an embodiment of the present invention, at least one ridge formation extends along the first region of the treatment member dividing the first region into at least two separated channels along which the treatment liquid can flow. The or at least one of the ridge formations may engage an inner surface of the upper solar energy transmission wall. The treatment liquid supply means may include a treatment reservoir positioned at or adjacent an upper end of the first region of the treatment member, a wicking material being provided to transfer the treatment liquid from the treatment liquid reservoir to an upper end of the first region of the treatment member to flow gravitationally downwardly thereon. In an embodiment of the present invention, a thin porous layer or layers at least partially cover the first region. The thin porous layer or layers may also act as the wicking material. The treatment chamber may be defined by a first upper wall forming the solar energy transmission wall, and a second lower wall, each of the first upper wall and the second lower wall being substantially spaced from the treatment member.

It is possible to utilize water that is heated, for example, from an industrial, mining or geothermal application either in combination with or without the application of solar energy. In accordance with such an aspect, embodiments of the invention may provide a still module, in use, being inclined to the vertical, having a treatment chamber defined by a first upper wall of a flexible polymer sheet material and a second lower wall of a flexible polymer sheet material, a treatment member positioned within the treatment chamber spaced below the first upper wall and above the second lower wall whereby a convection heat flow space is formed above and below the treatment member, the treatment member being formed from a thin metal material as a tray having a tray base forming a first region of the treatment member and a perimeter wall extending upwardly from the tray base along at least side and lower edges of the tray base, the first region having an upwardly facing surface or surfaces that are hydrophilic to a treatment liquid supplied thereto, liquid supply means for supplying the treatment liquid in preheated condition to at least an upper end zone of the first region of the treatment member whereby the treatment liquid is disposed in a thin treatment flow or flows over the first region gravitationally downwardly thereon, the upwardly facing surface or surfaces of the first region being at least partially covered by a porous, preferably absorbent, material layer, a component of the preheated treatment liquid on the first region being at least partially evaporated to form a condensate on an inwardly facing surface of the first upper wall of the still module, said first inwardly facing surface having a hydrophilic surface relative to the condensate whereby the condensate flows downwardly thereon to be collected and discharged from the still module. The still module may be capable of a hybrid operation whereby the solar energy is also applied to the first upper wall, the first upper wall being clear or highly translucent to allow solar energy to enter the treatment chamber. Other features or aspects described herein may equally apply to this hybrid type still module.

The treatment liquid utilized in the above described still modules may be saline water such as sea water, bore or artesian water, or water contaminated with undesirable materials or substances including, for example algae created, for example in industrial, mining or other applications. The condensate formed utilizing such treatment liquids may be clean water. While the creation of fresh or clean water is a major application of the stills as disclosed herein, other applications could include the separation of alcohol such as ethanol from a liquid feed source where the alcohol is separated by evaporation and forms the collected condensate. In most applications, multiple solar still modules described herein might be used in an installation where any treatment liquid remaining after passing through one solar still module may be utilized as at least part of the input to a downstream solar still module. In other applications where the feed treatment liquid is saline or salt loaded water such as sea water, the solar still module may also be used to concentrate the salt level in the treated feed liquid to ultimately produce salt therefrom.

Control of the supply of treatment liquid to the treatment member may be via an on/off valve in the treatment liquid feed line to the still module that is controlled in response to one of a solar radiation sensor, temperature sensor sensing the temperature of the treatment member or a sensor sensing the degree of wetness of the treatment member. It is desired to maintain a steady supply of treatment liquid to the treatment member without having an excessive flow reaching a lower level of the treatment member to have to be drained therefrom.

Preferred embodiments of the present invention will be described hereafter with reference to the accompanying drawings.

### BRIEF DESCRIPTION OF THE DRAWINGS

FIG. 1 is a perspective view of a solar still module constructed in accordance with an embodiment of the present invention;

FIG. 2 is a perspective view of a solar still module constructed in accordance with an embodiment of the present invention;

FIG. 3 is a section view along line III-III of FIG. 1, but including further embodiments of the present invention;

FIG. 4 is a partial section view showing an alternative connection arrangement for the edge regions of the upper and lower outer sheet members of the outer envelope of the solar still module shown in FIGS. 1 and 2;

FIG. 5 is a section view similar to FIG. 3 taken along line V-V of FIG. 2;

FIGS. 6 and 6a are partial section views along line VI-VI of FIG. 2 showing two embodiments of the present invention; and

FIGS. 7 and 7a are partial section views along line VII-VII of FIG. 2 showing possible alternative embodiments for feeding treatment liquid to the solar still module.

### DETAILED DESCRIPTION OF THE DRAWINGS

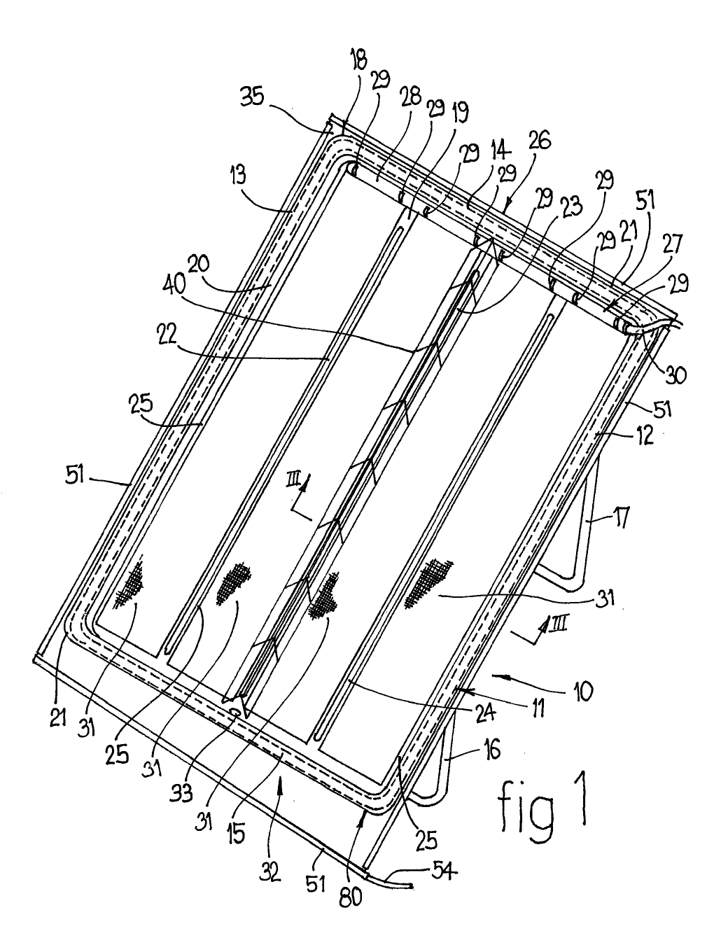

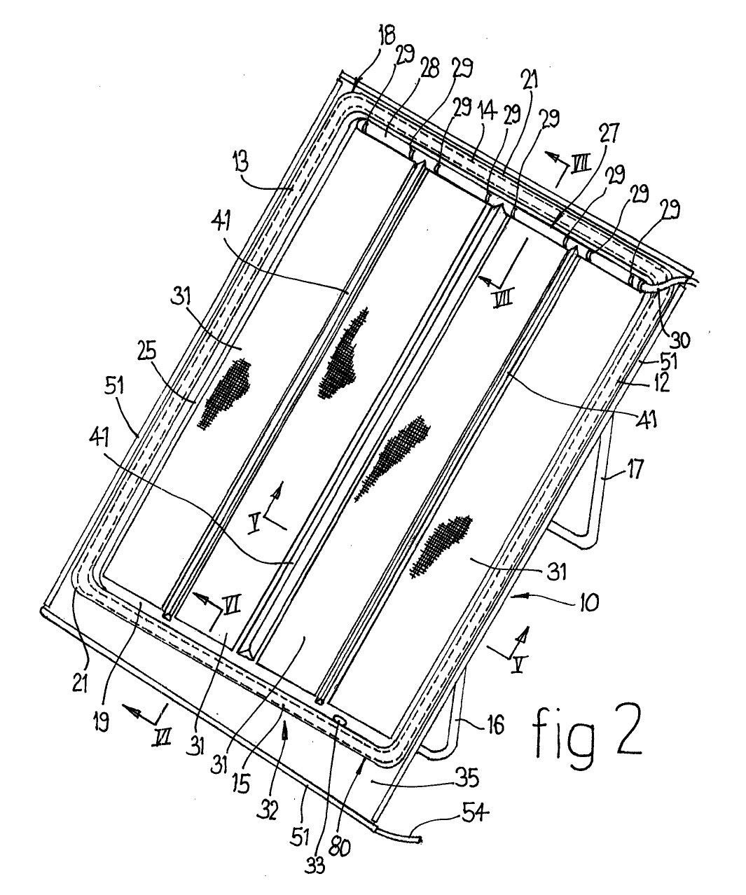

Referring to FIGS. 1 and 2, a solar still module 10 according to preferred embodiments of the present invention, has a generally rectangular perimeter support frame 11 with longer side edge members 12, 13 and shorter end edge members 14, 15. In use the support frame 11 is supported by forward legs 16 and rear legs 17 such that the support frame 11 and thereby the solar still module 10 is supported at an inclined angle to the horizontal. Any other form of support structure could also be employed. The perimeter support frame 11 is formed by galvanized metal tubing or pipe but any other form of elongate support frame material could also be employed. The angle of inclination, in use, is between 10° and 50°, preferably about 30°.

A treatment panel member 18 in the form of a tray 80 having a base wall 19, upstanding perimeter walls 20 and an upper outwardly extending flange 21, is provided with the flange 21 being supported on the perimeter support frame 11. The treatment panel member 18 is formed by pressing aluminium or aluminium alloy foil or sheet material into the desired shape and configuration with a thickness sufficient to be self supporting in use as described hereafter. The tray 80 of the treatment panel member 18 can be made from a heat conductive material and other metals including copper and copper alloys or stainless steel could also be used. It is of course also possible to use other non metallic materials, however, most metals will provide a heat radiation reflective surface facing upwardly from the base wall 19.

The base wall 19 of the treatment panel member 18 may present an upwardly facing planar surface or as is represented in FIG. 1, a plurality of upwardly facing planar surfaces 25 divided by stiffening ribs 22, 23 and 24 extending longitudinally along the base wall 19. The stiffening ribs 22, 23 and 24 may be permanently formed in the wall thickness of the base wall 19. Each of the surfaces 25 may be treated to provide a hydrophilic liquid flow over the surface. This may be via treating the surface directly or by applying a clear or translucent coating with such a surface formed thereon. A clear or translucent layer of polymer material that is acid etched on its surface or is coated with silicon oxide, aluminium oxide, titanium oxide or another suitable material may be provided to cover the upwardly facing surface or surfaces 25 to provide a hydrophilic surface thereon. It has also been recognized that aluminium oxide that forms on an aluminium surface naturally forms a hydrophilic surface on the upwardly facing surfaces 25. A hydrophilic surface allows liquid flow in the surface 25 to spread out in a thin film as opposed to beading in a droplet or stream like flow, which has been found to substantially improve the transfer of solar heat energy to the liquid and thereby improve the evaporation of a desired component from the liquid.

Located at the upper end 26 of the treatment panel member 18 is a delivery arrangement 27 for delivering treatment liquid to the upper end 26 of the treatment panel member 18. In the embodiments illustrated in FIGS. 1 and 2, the delivery arrangement 27 comprises a header pipe 28 with a plurality of spaced discharge openings 29 along its length. The discharge openings 29 are slots formed in the header pipe 28 extending in a circumferential (or upright) direction. The header pipe 28 is made of a material capable of withstanding temperatures that prevail within the still module 10. A metal pipe may be used but other suitably high temperature resistant materials could also be utilized. A delivery pipe 30 feeds the treatment liquid from an external source (not shown) to the header pipe 28. The discharge openings 29 deliver treatment liquid to spaced locations across the base wall 19 of the treatment panel member 18 and specifically in the embodiment illustrated in FIG. 1, to the surfaces 25. While the drawings show only one upper header pipe 28 at an upper end of the surfaces 25, it is possible also to provide multiple supply means at intermediate locations along the surfaces 25. On each of the surfaces 25, a porous material layer 31 extends substantially across the surface 25 and substantially along the surface 25 from the upper end 26 to the lower end 30, 32 of the solar still module 10. A single porous material layer 31 might be provided covering the complete upper face of the base wall 19 in another embodiment. The treatment liquid flows onto and through the porous material layer 31 to spread across the base wall surfaces 25 in a thin film flow. Solar energy as described hereafter heats this thin liquid film flow and the desired component is evaporated to pass as a vapor upwardly through or from the porous layer 31. The porous layer 31 may be a woven or non-woven material and may be absorbent or hydrophilic in nature. Suitable materials include polypropylene, polyester and polyester blended material, for example a blend of polyester and rayon. The materials should, where possible be UV stabilized to improve their life in use. Natural fibers including wool could also be used such as in the form of a wool felt material. In an embodiment of the present invention, the material of the layer or layers 31 is absorbent to the treatment liquid and will have a weight of less than 200 gm/square meter and preferably between 10 and 80 gm/square meter. The porous material layer or layers 31 may be fabric material or netting material and the or each layer 31 may be secured to the underlying treatment panel member 18 at least one location. The connection may be via Velcro fastening means or other suitable releasable means to enable the material layer or layers 31 to be replaced from time to time as may be required. Materials in the treatment liquid may also settle out and be retained in the porous material layer or layers 31. If these materials have value, then, after use, the layers 31 could be processed to recover those materials. This may include, for example, valuable minerals, metals including gold, and other substances.

Any treatment liquid that reaches the lower end 32 of the solar still 10 can be collected and drained through a drainage outlet 33 suitably located in the treatment panel member 18. Suitable drainage pipes (not shown) leading from the drainage outlet 33 may be provided leading through the lower sheet of the still module to direct this liquid to a collection point or to be recycled to be reintroduced into the same or to a further solar still module.

The outer enclosure 34 of the solar still module 10 can be formed by an upper sheet of flexible or semi rigid plastics material 35 that is either clear or highly translucent and a lower sheet of flexible plastics material 36. The plastics material of the upper and lower sheets 35, 36 may be semi rigid, is generally not resilient or elastic, but is durable and hard wearing in use. In an embodiment, it is also impact resistant. Suitable materials include PET plastic sheet material, polycarbonate sheeting, polypropylene, polyethylene, acrylic, acetyl or similar polymeric sheet materials. In an embodiment, the material be capable of being preformed into a desired shape by heat forming or similar to form cooperable upper and lower trays or edge formations capable of use with flexible fastening means as described in greater detail below. In an embodiment, either the material of at least the upper sheet of plastics material 35 exhibit hydrophilic characteristics to the condensate intended to be formed or at least the inner surface of the upper sheet of plastics material 35 exhibit such hydrophilic characteristics. This may be achieved by laminating such a hydrophilic layer to the inner surface of the sheet of plastics material 35. Such a material might be an oxide material such as silicon oxide, titanium oxide, aluminium oxide, or similar materials exhibiting suitable hydrophilic characteristics. The inner surface layer may be separately formed and adhered to the inner surface by a clear or highly translucent adhesive or it may be laminated to the base material of the upper sheet material 35 by co-extrusion or any other technique including coating techniques. In another embodiment, the entire material of the upper sheet member 35 might be formed by a material exhibiting hydrophilic characteristics. In yet another embodiment, the hydrophilic surface may be formed by acid etching a base layer polymer material. In use when a condensate forms on the hydrophilic surface it forms into a film to spread over the surface and flows downwardly thereon. In doing so the upper wall clears to improve its solar energy transmission qualities. The lower sheet member 36 may be similarly constructed but the lower sheet member 36 does not need to be clear or highly translucent although it could be if desired. The provision of an inner surface 37 of the upper sheet member 35, at least, that is hydrophilic in nature, allows condensate formed thereon to flow more quickly to a lower collection point (as described below) while being spread out into a thin film thereby also minimizing possible obstruction by the condensate to solar energy entering the solar still module 10. The lower sheet member 36 may also desirably have a hydrophilic or hydrophobic inner surface 38 (at least) as some condensate may also form on this surface 38 and flow to the collection location as described in greater detail below, however, solar energy transmission through this wall is not a relevant issue with the performance of the module.

As shown in FIG. 1, at least one spacer member 40 may be provided, extending in a longitudinal direction to keep the inner surface 37 of the upper sheet member 35 spaced above the base wall 19 of the treatment panel member 18. The inner surface 37 is maintained, at least approximately, a relatively uniform distance above the base wall 19, with this distance being relatively small to minimize the volume within the solar still module 10. The spacer member 40 may be a wire, rod or similar mesh material or a relatively clear/translucent plastic material that will provide minimal obstruction to solar energy directed towards the surface or surfaces 25 of the treatment panel member 18. FIG. 2 illustrates an embodiment where the spacer member 40 is replaced with extended flange elements 41 pressed or roll formed from the base wall 19 of the treatment panel member 18 that extend longitudinally and maintain the inner surface 81 of the upper sheet member 35 spaced from the base wall surfaces 25 (see FIG. 5). One or more spacer members 42 may be provided between the rear surface 43 of the base wall 19 of the treatment panel member 18 and the inner surface 82 of the lower sheet member 36. The spacer member or members 42 may extend longitudinally or transversely and may be constructed by inflatable members or by mesh material or similar to allow gas or vapor circulation within the still module in the space created between the lower sheet member 36 and the rear surface 43 of the base wall 19. The rear spacer member or members 42 also should be configured to minimize obstruction to condensate flow on the inner surface 82 of the lower sheet member 36 as some condensate also forms thereon and flows downwardly to the condensate collection zone. The rear spacer member or members 42 may also be omitted in some applications where gravity ensures the required spacing between the lower sheet member 36 and the treatment panel member 18. A treatment chamber 85 is thus formed between the inner surfaces 81, 82 of the upper and lower sheet members 35, 36 with an upper zone 86 above the treatment member 18 and a lower zone 87 below the treatment member 18. Spacer members (not shown) may be positioned at upper and lower ends of the treatment panel member 18 to ensure a convection circulation space is formed above, below and around the treatment panel member 18. Convection flow, in use occurs upwardly above the panel member 18 and downwardly below the panel member 18.

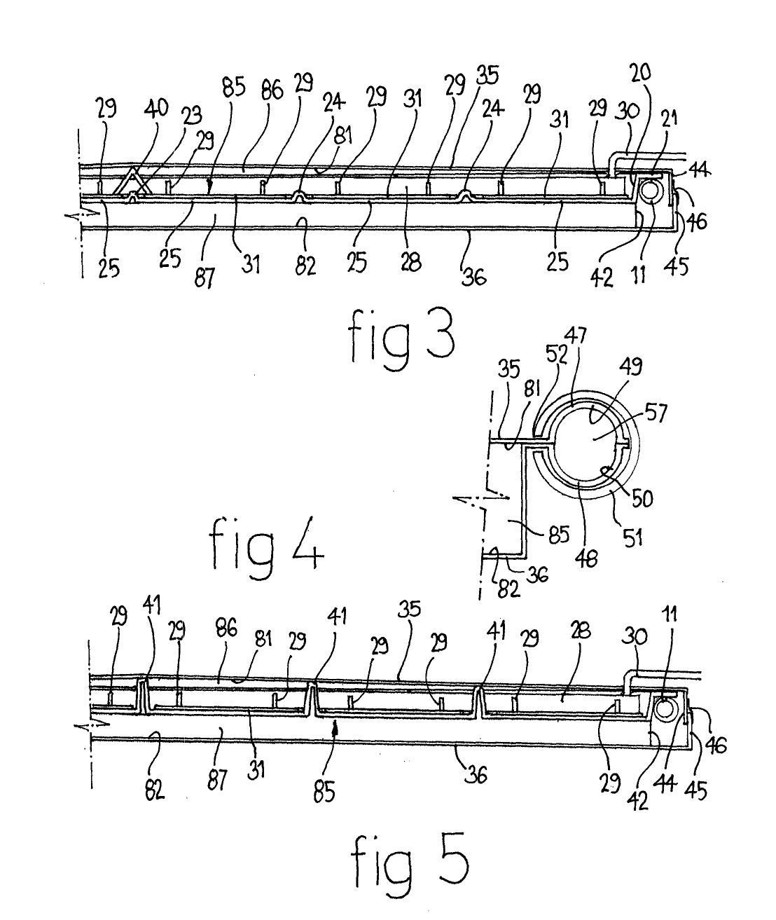

As is shown in FIGS. 3 and 5, the upper and lower sheet members 35, 36 may be preformed as tray or shell members with their peripheral edge zone 44, 45 interengaging and secured by tape 46 or any other suitable means including clamps. While the solar still 10 should provide a largely closed internal environment, it is not essential that the internal space be completely air tight. While FIGS. 3, 5 show the sheet members 35, 36 as trays or shells, it would equally be possible to have one or the other formed as a flat sheet member. FIG. 4 illustrates another embodiment of the connection between the adjacent edge zones of the upper and lower sheet members 35, 36. In this construction, each edge zone 47, 48 has a semi-circular edge zone ridge formation 49, 50 arranged, in use, to confront one another. A circular retainer tube 51 with a longitudinal slit 52 formed therein is then slipped over the confronting edge formations 49, 50 so that they are then prevented from moving laterally or transversely relative to the retainer tube 51. As can be seen in FIGS. 1 and 2, each of the opposed side edges and the upper and lower end edges of the solar still module 10 can be secured by retainer tubes 51. If the internal regions of the solar still module 10 need to be serviced in any way, then it is an easy process to slip one or more of the retainer tubes 51 off the assembly to allow access to the internal regions of the solar still module 10.

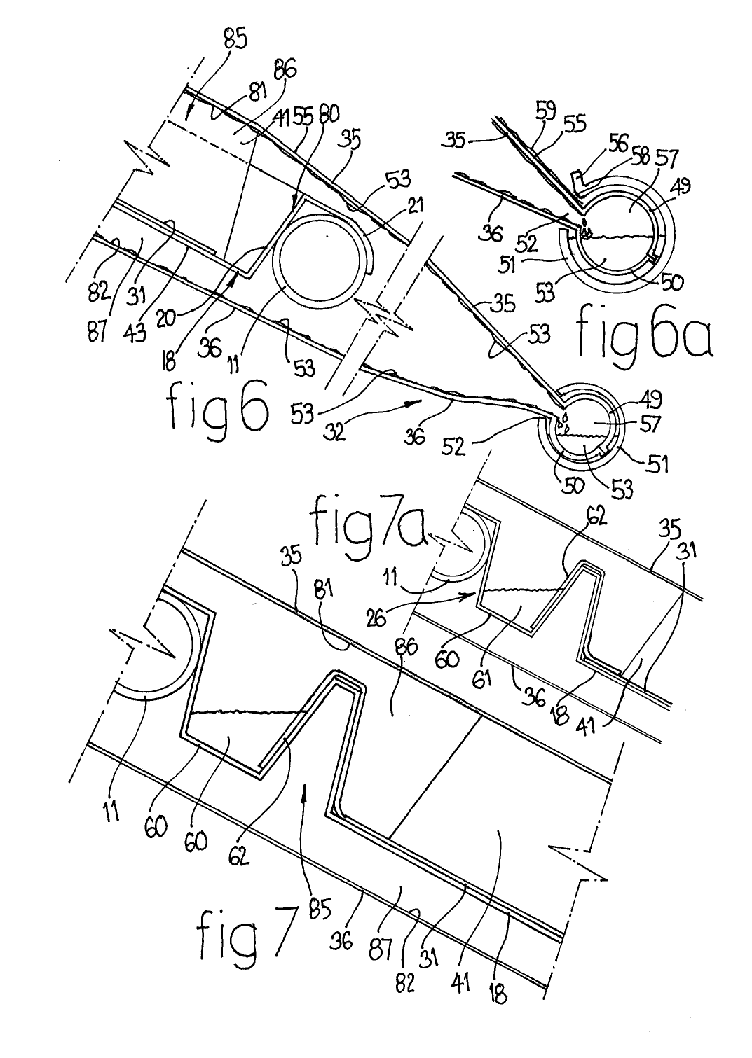

FIG. 6 of the annexed drawings shows in partial cross-section an embodiment of the configuration for collecting condensate 53 at the lower end 32 of the solar still module 10. The lower end of the upper and lower sheet members 35, 36 are joined by a fastening arrangement similar to that shown in FIG. 3. In this case, the longitudinal slit 52 has a width permitting condensate 53 formed on the inner surface 81 of the upper sheet member 35 to flow by gravity downwardly on the inner surface 81 and into the internal zone 57 defined by the edge zone formations 49, 50 and the retainer tube 51. Any condensate 53 formed on the inner surface 82 of the lower sheet member 36 also flows downwardly by gravity and into the space 57. As can be seen in FIGS. 1 and 2, the lower retainer tube 51 may be inclined downwardly to one side such that condensate collected therein can flow gravitationally to that side and be discharged via a condensate line 54. When the condensate 53 is clean water, it may be desirable to also provide a means for collecting rain water 59 falling on the outer surface 55 of the upper sheet member 35 as shown in FIG. 6a. In such an embodiment, rain falling on the outer surface 55 might flow downwardly thereon to be captured by the upwardly turned flange 56 and directed into the interior zone 57 thereby. If desired one or more zones of increased width can be provided along the length of the retainer tube 51 between the throat 58 and the outer surface 55 of the sheet member 35 to improve water flow into the interior zone 57.

FIGS. 7 and 7a illustrate embodiments where the delivery arrangement 27 for the treatment liquid may be a trough reservoir 60 extending across the upper end 26 of the panel member 18, the trough reservoir 60 receiving treatment liquid 61 from a suitable delivery pipe such as pipe 30 in FIGS. 1, 2. The treatment liquid is then wicked from the trough reservoir by a wicking material layer 62. The wicking material layer 62 may be an extension of the porous material layer or layers 31 (FIG. 7) or it may be a separate layer as shown in FIG. 71. Such an arrangement makes it less critical for the treatment panel member 18 to be substantially level in a transverse direction to achieve a uniform supply of treatment liquid to the surface or surfaces 25.

Testing of solar still modules constructed in accordance with embodiments of the present invention has been carried out with a comparison to the SUNSURE prior art solar still module. Three desalination solar still modules according to the present invention were positioned on property forty five kilometres north of Melbourne, Victoria, Australia with each still module facing in a northward direction. A first one of these solar still modules identified as A was constructed generally in accordance with the still module shown in FIG. 1. The second and third of these still modules identified as B and C respectively were constructed generally in accordance with FIG. 2.

Bore water pumped from a tank onsite, was used as the feed to the solar still modules A, B and C. The ground water had previously been tested for total dissolved solids (TDS), pH, and contaminants. It was not the purpose of these tests to verify the quality of water beyond random measurements of the conductivity of the product water over the course of production. Tests conducted confirmed a TDS concentration of the order of 1700 ppm for the feed water delivered into the stills during the testing period. The distilled water (condensate) produced was also tested, with TDS concentrations ranging from 1-20 ppm. Waste water from the solar still modules A, B and C reached up to 2500 ppm TDS, confirming the concentration of salts in the waste stream.

Operation of the solar stills commenced at 9:00 AM on each of two days, with flow rate being adjusted to approximately 4 L/hr through the still modules. The distilled water was collected at the bottom of the still and was piped to a receiving vessel. The volume of water produced during the hour was measured using a 500 mL graduated cup. The pump was stopped at 6:00 PM and the water evaporated overnight was collected the following morning prior to start up.

In order to verify the solar efficiencies of the units, the level of solar radiation received each hour was measured. A Campbell Science weather station had previously been set up on site also northward facing. This station was set up to record the hourly and daily solar radiation received onsite.

Additionally, to further verify efficiency, a SUNSURE (S) solar still was also operated. This still was filled with water at 9:00 AM each morning and allowed to operate for the day without refilling. At the end of each production day the volume of water produced was measured and the efficiency calculated for comparison.

To calculate the solar efficiencies of the solar still modules, solar radiation received during the hour was collected from the weather station and used to calculate the theoretical limit of water that could be produced, represented by the following equation:

P_{T}=R_{S}/H_{VAP} (Equation 1)

Where,
P_{T}=Theoretical production rate of water based on 100% efficiency (L/m²)
R_{S}=Solar Radiation received during the hour (MJ/m²)
H_{VAP}=Heat of vaporisation of water (kJ/L)

The efficiency was then calculated by measuring the volume of water produced during the hour divided by the theoretical limit of water that could have been produced, represented by the following equation:

nₛ=(P_{R}/P_{T})×100 (Equation 2)

Where,
nₛ=Solar Efficiency,
P_{R}=Real production rate of water produced during the hour (L/m²)
P_{T}=Theoretical production rate of water based on 100% efficiency (L/m²)

On the first day of testing, the test results are shown in Table 1 below:

TABLE 1

| | Volume of | Production | |
|---|---|---|---|
| | water produced | Rate of Water | Final Solar |
| UNIT | (L) | (L/m²) | Efficiency |
| A | 15.10 | 5.03 | 53.0% |
| B | 16.34 | 5.45 | 60.5% |
| C | 15.47 | 5.16 | 55.3% |
| S | 1.825 | 3.80 | 40.0% |

On the second day of testing, a number of the hours of production were disrupted by cloud; however the temperature did climb to about 35° C. Table 2 below lists the results of the four solar still modules A, B, C and S.

TABLE 2

| | Volume of | Production | |
|---|---|---|---|
| | water produced | Rate of Water | Final Solar |
| UNIT | (L) | (L/m²) | Efficiency |
| A | 9.925 | 3.31 | 46.7% |
| B | 11.30 | 3.77 | 50.9% |
| C | 11.10 | 3.70 | 49.9% |
| S | 1.20 | 2.55 | 35.4% |

A summary of the test results are shown in Table 3 below:

TABLE 3

| | First Day | Second Day |
|---|---|---|
| Maximum Temperature | 30.6° C. | 35.5° C. |
| Sunshine Hours | 11.0 | 8.7 |
| Solar Efficiency (A, B, C) | 55-61% | 50-51% |
| Solar Efficiency (S) | 40% | 35% |
| | Product | Waste |
| Measured TDS | 1.0-15.0 | 2250-2500 |
| ppm | | |

The test results demonstrate that solar still modules according to embodiments of the present invention have a solar efficiency level of 50 to 65% and they are more efficient than the SUNSURE solar still module.

Many variations and modifications to the disclosed embodiments falling within the scope of the annexed claims are possible.

1. A solar still module having a treatment chamber including a treatment member positioned below an upper extremity of the treatment chamber, a treatment liquid supply means supplying treatment liquid to an upper end of a first region of the treatment member, the first region having, in use, at least one inclined upwardly facing surface to promote the treatment liquid flow gravitationally downwardly on the first region of the treatment member in one or more flows, the upwardly facing surface or surfaces of the first region being hydrophilic relative to the treatment liquid whereby the treatment liquid spreads into a thin film on the upwardly facing surface or surfaces of the first region, the first region further including at least one porous material layer at least partially covering the or each the upwardly facing surface or surfaces, the treatment chamber having an upper solar energy transmission wall positioned above the first region of the treatment member enabling solar energy to be applied at least to the first region of the treatment member to at least partially evaporate a component of the treatment liquid on the first region, the evaporated component being at least partially condensed on an inner surface of the upper solar energy transmission wall to form a condensate, said the condensate being collected therefrom at a lower location or locations by condensate collection and discharge means leading from the treatment chamber.

2. A solar still module according to claim 1 wherein the upwardly facing surface or surfaces of the first region is capable of reflecting solar energy

3. A solar still module according to claim 1 wherein the upwardly facing surface or surfaces of the first region of the treatment member are heat conductive.

4. (canceled)

5. A solar still module according to claim 1 wherein said upper solar energy transmission wall includes an inner facing clear or highly translucent hydrophilic surface relative to the condensate formed thereon.

6. A solar still module according to claim 5 wherein the upper solar energy transmission wall includes a first sheet of a preformed flexible polymer material.

7. A solar still module according to claim 6 wherein the preformed flexible polymer material is polycarbonate, PET, polypropylene, polyethylene, acrylic, or acetyl.

8-9. (canceled)

10. A solar still module according to claim 3 wherein the treatment member is a preformed sheet metal member having a first inclined wall forming the first region, preferably being aluminium, copper, alloys of aluminium or copper, or stainless steel.

11-15. (canceled)

16. A solar still module having a treatment chamber including a first upper solar energy transmission wall formed by a preformed polymer sheet material positioned at or above an upper extremity of the treatment chamber having a preformed laterally extending formation along at least one edge region enabling the preformed polymer sheet material to be connected to the treatment chamber, the solar energy transmission wall being clear or highly translucent at least in a first region intended to transmit solar energy into the treatment chamber, the solar energy transmission wall providing an inner hydrophilic surface on which an evaporated component condenses to form a condensate, the treatment chamber further having a second lower wall formed by a second sheet of a preformed polymer material having a preformed laterally extending formation along at least one edge region, the preformed laterally extending formations on the first upper and the second lower walls being connectable to form the treatment chamber.

17-18. (canceled)

19. A solar still module having a treatment chamber including a treatment member positioned below an upper extremity of the treatment chamber, a treatment liquid supply means supplying treatment liquid at least to an upper end of a first region of the treatment member, the first region of the treatment member being formed from a thin metal sheet material whereby the treatment liquid delivered by the treatment liquid supply means is disposed in a thin treatment liquid film flow or flows over the first region to flow gravitationally downwardly thereon, the treatment chamber having an upper solar energy transmission wall positioned above the first region of the treatment member enabling solar energy to be applied at least to the first region to evaporate at least a portion of a component of the treatment liquid, the evaporated component being at least partially condensed on an inner surface of the upper solar energy transmission wall to form a condensate thereon, the upper solar energy transmission wall of the treatment chamber being formed by a first sheet of a preformed polymer material having a preformed laterally extending formation along at least one edge region, the upper solar energy transmission wall, in use, being clear or highly translucent with a hydrophilic inner surface relative to the condensate whereby the condensate formed thereon spreads into a film to flow downwardly thereon to the lower location or locations for collection, the treatment chamber further having a lower wall formed by a second sheet of a preformed polymer material having a preformed laterally extending formation along at least one edge region.

20. A solar still module having a treatment chamber including a treatment member positioned below an upper extremity of the treatment chamber, a treatment liquid supply means supplying treatment liquid at least to an upper end of a first region of the treatment member formed from a thin metal sheet material whereby the treatment liquid delivered by the treatment liquid supply means is disposed in a thin treatment liquid film flow or flows over the first region, the treatment chamber having an upper solar energy transmission wall positioned above the first region of the treatment member enabling solar energy to be applied at least to the first region of the treatment member to evaporate at least a portion of a component of the treatment liquid, the evaporated component being at least partially condensed on an inner surface of the upper solar energy transmission wall to form a condensate that is collected therefrom at a lower location or locations by condensate collection and discharge means leading from the treatment chamber, the treatment chamber being formed by a first upper member of a polymer sheet material and by a second lower member of a polymer sheet material, at least some edge regions of the first upper member and the second lower member having formations formed along the edge regions extending laterally therefrom, the solar still module further including at least one tubular retainer member engaging a the edge region of the first upper member and said the second lower member whereby the formations formed along a the edge region are retained by the tubular retainer member.

21-23. (canceled)

24. A solar still module having a treatment chamber including a treatment member positioned below an upper extremity of the treatment chamber, a treatment liquid supply means supplying treatment liquid at least to an upper end of a first region of the treatment member whereby the treatment liquid delivered by the treatment liquid supply means is disposed in thin treatment liquid film flow or flows over the first region to flow gravitationally downwardly thereon, the treatment chamber having an upper solar energy transmission wall positioned above the first region of the treatment member enabling solar energy to be applied at least to the first region of the treatment member to evaporate at least a portion of a component of the treatment liquid, the evaporated component being at least partially condensed on an inner surface of the upper solar energy transmission wall to form a condensate that is collected therefrom at a lower location or locations by condensate collection and discharge means leading from the treatment chamber, the upper solar energy transmission wall of the treatment chamber being formed by a clear or highly translucent polymer material layer with a hydrophilic inner surface relative to the condensate, the water treatment member being formed from a thin metal material as a tray having a tray base having an upwardly facing metal surface forming the first region, a perimeter wall extending upwardly from the tray base along at least side and lower edges of the tray base, and an outwardly extending flange extending from an upper region of the perimeter wall, the flange being supported on a support frame.

25. A solar still module according to claim 20 wherein the first region of the treatment member has at least one upwardly facing hydrophilic surface.

26. A solar still module according to claim 25 wherein the hydrophilic surface is formed by an oxide layer on the first region.

27. A solar still module according to claim 20 wherein the thin sheet metal is selected from aluminium, copper, alloys of aluminium or copper, or stainless steel.

28-32. (canceled)

33. A still module, in use, being inclined to the vertical having a treatment chamber defined by a first upper wall of a flexible polymer sheet material and a second lower wall of a flexible polymer sheet material, a treatment member positioned within the treatment chamber spaced below the first upper wall and above the second lower wall whereby a convection heat flow space is formed above and below the treatment member, the treatment member being formed from a thin metal material as a tray having a tray base forming a first region of the treatment member and a perimeter wall extending upwardly from the tray base along at least side and lower edges of the tray base, said the first region having an upwardly facing surface or surfaces that are hydrophilic to a treatment liquid supplied thereto, liquid supply means for supplying the treatment liquid in preheated condition to at least an upper end zone of the first region of the treatment member whereby the treatment liquid is disposed in a thin treatment flow or flows over the first region gravitationally downwardly thereon, the upwardly facing surface or surfaces of the first region being at least partially covered by a porous, preferably absorbent, material layer, a component of the preheated treatment liquid on the first region being at least partially evaporated to form a condensate on an inwardly facing surface of the first upper wall of the still module, the first inwardly facing surface having a hydrophilic surface relative to the condensate whereby the condensate flows downwardly thereon to be collected and discharged from the still module.
